(19) United States
(12) Patent Application Publication
(10) Pub. No.: US 2009/0157672 A1
(43) Pub. Date: Jun. 18, 2009

(54) METHOD AND SYSTEM FOR MEMORY AUGMENTATION

(76) Inventor: Sunil Vemuri, Santa Clara, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 12/393,015

(22) Filed: Feb. 25, 2009

Related U.S. Application Data
(63) Continuation-in-part of application No. 11/560,295, filed on Nov. 15, 2006.

(51) Int. Cl. G06F 17/30

(52) U.S. Cl. 707/5; 707/3; 707/E17.014; 707/E17.017; 707/E17.015

(57) ABSTRACT

In a method for memory augmentation, a contextual factor is detected for a user, a query is selected for a database based upon the contextual factor, a query result is received with one or more reminders relevant to the user and a reminder has information relevant to at least one of recalling and reinforcing a memory, any number of reminders are selected from the query result based upon an estimation of information beneficial for the user to receive, and sending information from the selected reminders for presentation on a communication channel with at least one of the information for presentation and the communication channel is selected based upon at least one of a situation and a state for the user.

### CROSS-REFERENCE TO RELATED APPLICATIONS

This application is related to copending U.S. patent application Ser. No. 11/560,295, entitled “Memory Assistance System and Method,” filed on Nov. 15, 2006, which is hereby incorporated herein by reference.

### BACKGROUND

A person's memory is a store of information retained by a person from the person's activities or experiences and the information from the person's memory may be subsequently recalled by the person. A particular memory may refer to a particular piece of stored information from a person's memory. Approaches for helping one store and recall information have largely focused on attempts to replace or substitute one's memory with a tool, such as calendaring tools and task list tools. Calendaring and task list tools allow a user to input meeting and task descriptions as well as a time to send a reminder for the meeting or task, and the tool will send scheduled alerts to a user to indicate a need to attend a meeting at a specified time before the meeting or a task is due. Another category of approaches include tools that help improve one's memory for specific tasks, such as studying for exams. The exam studying tools schedule times for review of material for an exam in accordance with theories on how best to memorize material for an upcoming exam. However, these approaches focus on alerting one of information when one is aware of the need to be reminded.

### SUMMARY

Embodiments of a method, system, and computer-readable medium are disclosed for memory augmentation. In an embodiment, a contextual factor is detected for a user, a query is selected for a database based upon the contextual factor, a query result is received with one or more reminders relevant to the user and a reminder has information relevant to at least one of recalling and reinforcing a memory, any number of reminders are selected from the query result based upon an estimation of information beneficial for the user to receive, and sending information from the selected reminders for presentation on a communication channel with at least one of the information for presentation and the communication channel is selected based upon at least one of a situation and a state for the user.

In another embodiment, information from a selected reminder for presentation on a communication channel is received and selection of at least one of the information for presentation and the communication channel is based upon at least one of a situation and a state for the user, and the selected reminder is selected by detecting a contextual factor for a user, selecting a query for a database based upon the contextual factor, receiving a query result comprising one or more reminders relevant to the user and a reminder comprises information relevant to at least one of recalling and reinforcing a memory, and selecting a reminder from the query result based upon an estimation of information beneficial for the user to receive.
In another embodiment, a contextual factor sensor is configured to detect a contextual factor for a user, a processor is operable to execute a set of instructions, and a computer-readable medium is in communication with the processor and the computer-readable medium is operable to store a set of instructions that are configured to select a query for a database based upon the contextual factor, receive a query result comprising one or more reminders relevant to the user and a reminder comprises information relevant to at least one of recalling and reinforcing a memory, select any number of reminders from the query result based upon an estimation of information beneficial for the user to receive, and send information from the selected reminders for presentation on a communication channel and at least one of the information for presentation and the communication channel is selected based upon at least one of a situation and a state for the user.

In another embodiment, a computer-readable medium for memory augmentation, is operable to store a set of instructions that may be executed on a computer system, wherein the set of instructions are configured to detect a contextual factor for a user, select a query for a database based upon the contextual factor, receive a query result comprising one or more reminders relevant to the user and a reminder comprises information relevant to at least one of recalling and reinforcing a memory, select any number of reminders from the query result based upon an estimation of information beneficial for the user to receive, and send information from the selected reminders for presentation on a communication channel, wherein at least one of the information for presentation and the communication channel is selected based upon at least one of a situation and a state for the user.

In one or more embodiments, information may be selected from the query result to present to the user based on repetition estimation, forgetting estimation, overload estimation, or attention estimation of the user, a situation may be determined for a user from one or more contextual factors, one or more reminders may be ranked or filtered in the query result based upon an estimation, information from a reminder is a media clip, appropriate information may be learned from reminders presented to the user over time, a contextual factor may be obtained from a contextual factor sensor, a contextual factor sensor is a biometric sensor, and a contextual factor is a location.

### BRIEF DESCRIPTION OF THE DRAWINGS

FIG. 1 illustrates an exemplary flowchart for an implementation of memory augmentation.

FIG. 2a illustrates an exemplary block diagram for an implementation of memory augmentation.

FIG. 2b illustrates an exemplary graph of a forgetting curve for an implementation of memory augmentation.

FIG. 3 illustrates an exemplary flowchart for an implementation of memory augmentation.

FIG. 4 illustrates an exemplary block diagram for an implementation of memory augmentation.

FIG. 5 illustrates an exemplary flowchart for an implementation of presentation logic for memory augmentation.

FIG. 6 depicts an exemplary block diagram for a system architecture for a computer system.

### DETAILED DESCRIPTION

Embodiments of the present invention provide methods, systems, computer-readable mediums, and computer program products for memory augmentation. The inventor notes a need for an approach to memory augmentation that strengthens a user's memory by reinforcing a particular memory or helping the user to recall a particular memory in accordance with a situation/state that the user is experiencing. In one or more embodiments, predictions, estimation, and/or analysis may be performed in order to anticipate what information to present to a user that would help reinforce or recall a particular memory, and also what information may be appropriate for presentation to the user in accordance with their situation and/or state (situation/state). Contextual factors for a user may be gathered in order to determine a user's situation/state.

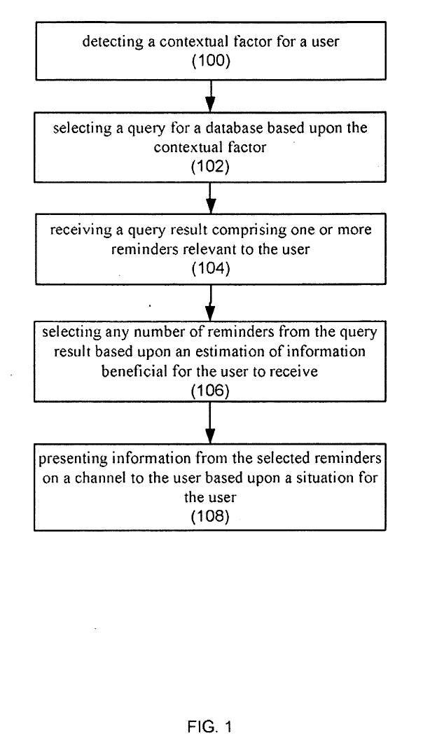

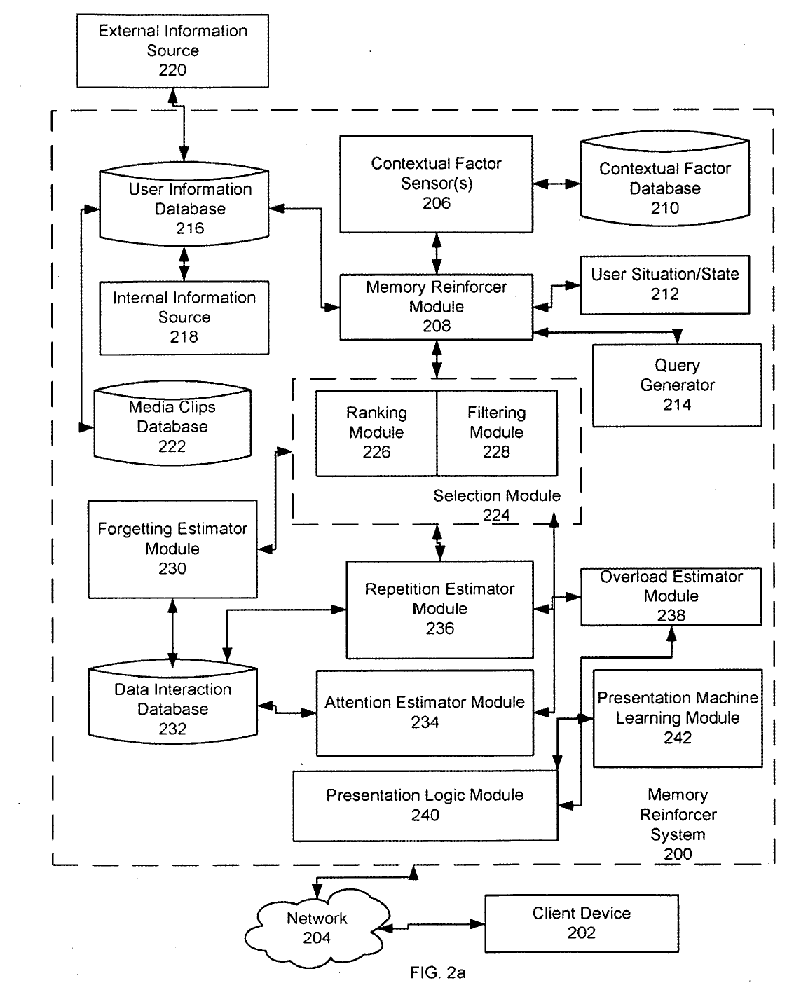

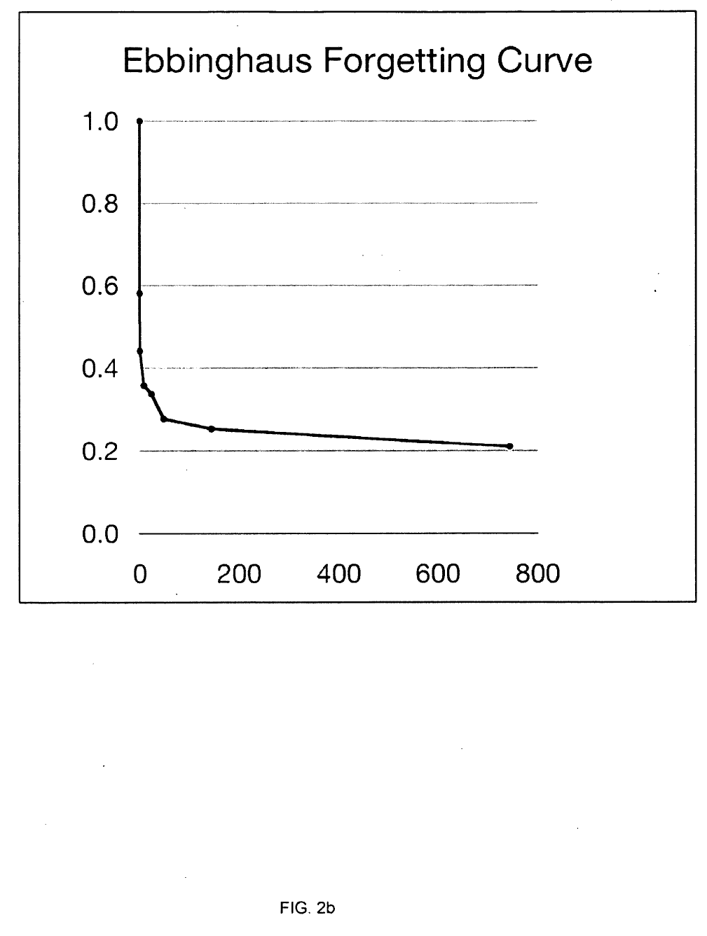

FIG. 1 illustrates an exemplary flowchart for an implementation of memory augmentation. Initially, a contextual factor for a user is detected (100). A contextual factor is data or information that may provides some indication of a user's situation/state. A user's state may be a condition of being and a user's situation may be the user's relation to their surroundings or environment. For example, a contextual factor of location information may indicate that a user is in close proximity to a grocery store. Contextual factors may include, but are not limited to, one or more topic(s) of interest, location information, persons in close proximity to the user, a user's recent thoughts or status, what a user has said or written, strength of relationship between a user and another person, a time, a time zone for the user, weather, temperature, user's mental or emotional state, user's activities, information obtained directly from the user concerning their state/situation, and software applications and/or devices used by a user. Examples of how contextual factors may be detected include, but are not limited to, using a mechanical sensor, a message received from a user with explicit direction sent to the memory augmentation system, and retrieving information from a server or third-party web service. Contextual factors may be obtained from contextual factor sensors which will be described in greater detail with FIG. 2.

One or more contextual factors may provide enough information to determine a state or a situation for a user. For example, a first contextual factor of location information obtained by a contextual factor sensor may indicate that a user is in close proximity or moving toward a meeting location and a second contextual factor may provide a description of the meeting at the meeting location. With the combination of the two contextual factors, the situation/state for the user may be that the user plans to attend the meeting provided in the second contextual factor. Those skilled in the art will recognize that a variety of contextual factors as well as determinations of situation/state for the user may be determined from the one or more contextual factors.

Continuing with FIG. 1, a query may be selected based upon the contextual factor (102). The inventor notes that the selection of a query based upon a contextual factor may enable the provision of reminders to the user that are relevant to the user's situation/state. In one or more embodiments, the query may be selected amid executed immediately following receipt of a detected contextual factor or a detected change in a contextual factor to ensure that the memory augmentation is relevant to the user's current situation/state. The selected query may be executed against a database that contains reminders for a user. A reminder has data and/or information (data/information) relevant to recalling and/or reinforcing a particular memory for a user. Reinforcing a particular memory may entail the provision of information in order to strengthen one's ability to store and retain the particular memory for subsequent recall. Reinforcement of the particular memory may be achieved by repeatedly presenting a user with information associated with a particular memory. In one or more embodiments, the detected contextual factor may directly determine the queries that are executed against the database to retrieve reminders for a user. For example, one or more contextual factors may indicate that a user is going to enter a meeting scheduled on the calendar, and queries may be selected that are relevant to the location of the user as well as all information provided in the description of the scheduled meeting. Continuing with the meeting description example, queries may be selected that provide reminders that are relevant to the location of the meeting, meeting participants, and topics of the meeting.

Next, a query result with one or more reminders relevant to the user may be received (104). The reminder may have information relevant to recalling or reinforcing a particular memory for the user. As detailed below with FIG. 2, the reminders may be obtained from both an internal or external source. The reminder may have metadata associated with the reminder that provides information on the reminder itself. For example, a reminder with text “get a report to John” (where John is a meeting participant) may have a due date that is associated with the reminder.

Any number of reminders from the query result may be selected based upon an estimation of information beneficial for the user to receive (106). The reminders from the query results may be ranked and/or filtered to allow for selection of appropriate reminders for presentation. For example, the reminders may be ranked and ordered in accordance with their due dates and/or textual relevance to a meeting description, and/or the reminders may be filtered such that only a number of reminders that are within a threshold for the user are selected. The ranking and filtering of reminders may produce no reminders that are beneficial for the user to receive.

The reminders may be selected based upon a forgetting estimation, attention estimation, repetition estimation, overload estimation, or any combination thereof. The estimation may indicate the information that is beneficial for the user to receive, and the reminders may be selected in accordance with the estimation. The forgetting estimation may provide a relative strength of a particular memory in the user's memory for the particular memory represented by the reminder. The attention estimation may provide an indication of a user's attention for a particular reminder. The attention estimation may provide an indication of how much attention the user can dedicate both overall and at the current moment in time. The repetition estimation may provide an indication of how often a reminder may be presented to ensure maximum retention for the reminder. The overload estimation may indicate a threshold for the user in receiving reminders. The selected reminders from the query results may be combined with selected reminders from one or more other query results, and the selected reminders that have been combined to form one group may be ranked and/or filtered.

Continuing (with FIG. 1, the user may be presented with information from any number of the selected reminders on a communication channel based upon a situation and/or a state for the user (108). Presentation logic, described in more detail below, may determine the information from reminders presented to the user and the one or more communication channel(s) chosen to present the information to the user in light of the user's situation/state. The entire reminder stored in a database may not be necessary to reinforce or recall a memory and as such, a portion of information in the reminder or gleaned from the reminder may be presented to the user.

As used herein, the term “user” is meant to be construed broadly to cover a person, a device and/or a software application, such that presentation to the user may entail receipt by a person, a software application, a device, or any combination thereof. As used herein, the terms “user's memory” is meant to be construed broadly to cover a memory of a person that may be augmented or enhanced by the memory augmentation methods, systems, computer-readable mediums, and computer program products and the terms “particular memory” are meant to be construed broadly to cover the particular memory for a person that may be stored in the user's memory.

FIG. 2a illustrates an exemplary block diagram for an implementation of memory augmentation. In FIG. 2, Client Device 202 interacts with a Memory Reinforcer System 200 according to an embodiment of a memory augmentation system. As will be appreciated by those skilled in the art, the functional elements of the Memory Reinforcer System 200 as illustrated in FIG. 2 are provided as an example, and various implementations of the system may have subsets of the functional elements and/or subsets may be distributed among various computer systems. In an embodiment, the Memory Reinforcer System 200 may be a server executing on a computer system and servicing request received from the Client Device 202 over a Network 204. In another embodiment, the Memory Reinforcer System 200 may be stored and executed as a stand-alone application on a computer system. The Memory Reinforcer System 200 may utilize push and/or pull technology to provide memory augmentation data/information to a Client Device 202. For example, the Client Device 202 may pull the data for memory augmentation by requesting the data be fetched by a server or the Client Device 202 may be pushed the data by a server that sends data without an explicit request to a server. The Memory Reinforcer Module 208 may be software that interacts with elements of the Memory Reinforcer System 200 to perform actions to enable memory augmentation for a user. The terms “memory enhancement,” “memory reinforcer,” and “memory reinforcement” are intended to refer to embodiments of systems, computer program products, computer-readable mediums, and methods of memory augmentation, and the terms may be used interchangeably throughout the present application.

A Client Device 202 may be used to receive information in order to enhance or augment the user's memory. Client Device 202 may include, but are not limited to, a mobile device, a smart phone, an Apple iPhone™, a cellular phone, a BlackBerry™ device, a personal digital assistant (PDA), a mp3 player, a laptop, a computer, telephone, or any other type of computer system. A Network 204 is an infrastructure for sending and receiving signals and messages according to one or more formats, standards, or protocols. The Network 204 may provide for both wired and wireless communication between the various elements of FIG. 2. Embodiments may rely on a Network 204 for communication between elements as depicted, including, but not limited to, Client Device 202, Contextual Factor Sensor 206, Memory-Reinforcer Module 208, Contextual Factor Database 210, User Situation/State 2.12, Query Generator 214, User Information Database 216, Internal Information Source 218, External Information Source 220, Media Clips Database 222, Selection Module 224, Ranking Module 226, Filtering Module 228, Forgetting Estimator Module 230, Data Interaction Database 232, Attention Estimator Module 234, Repetition Estimator Module 236, Overload Estimator Module 238, Presentation Logic Module 240, and Presentation Machine Learning Module 242.

As illustrated in FIG. 2, the Memory Reinforcer System 200 may have one or more Contextual Factor Sensor(s) 206 to detect contextual factor(s) for a user. Contextual factors may include, but are not limited to, a location, a time, a proximity to another person or device, an emotional state, data received by or sent to a user, data received that is associated with a user, an indication of memory strength, an indication of a user's thoughts and/or status, a topic(s) of interest to a user, information or data received by a user, physical sensors on devices, and information or data sent by a user. Examples of indications of user's thoughts/status may be obtained from information stored at a server and information on thoughts directly inputted by the user or another person in a message to the system. For example, information may be stored for a software calendaring service that has information on a user's thoughts. In another example, the user may indicate their current thoughts at a social networking service, such as Facebook (C) or Twitter (C), and the user may give permission for obtaining the user's thoughts from the social networking service. The user's status on a social networking site may state “John is happy” and a mental or emotional state for John of “happy” may be determined from the status. Indications of a user's thoughts/status may be determined from what the user has typed or said directly into the system or the indications may be imported from other sources, such as email on an email server. Location information may be obtained from a user logging in to software, turning on a computer system or device, headers from email messages, IP address of a computer, routing information, acoustic analysis, visual analysis, and/or a sensor on a device. Location information may be determined from a global positioning system (GPS) on a client device.

In one or more embodiments, the memory reinforcer may access data from a web service or server that can service requests from a client. The web service is an application programming interface (API) that can be accessed locally and over a network, such as the Internet, and allows for execution of instructions on a remote system hosting the requested service. For example, a user may allow the memory reinforcer to access data from the user's account at a social networking website to determine a user's situation/state. Data that may indicate contextual factors from a web service include, but are not limited to, a user's status, a user's location, a user's topics of interest, a user's shared topics of interests, a calendaring application, and proximity to a person in the user's network in order to determine the situation/state that the user may have experienced or is currently experiencing.

The Contextual Factor Sensor 206 may collect data or information to provide an indication of a user's situation or a user's state, Contextual Factor Sensor(s) 206 may include, but are not limited to, a method to collect information from a third-party server or application, a software application and data stored for use by the software application, a method to scan an email inbox, an email server or any other type of communications server, a method to scan text, audio data receiver and recorder, a method to scan data from images, biometric sensors, temperature sensors, environmental sensors, video cameras, aid any other type of sensor available on a device or computer system. A contextual factor sensor may track and/or monitor email data, calendaring data, audio data, visual data, and text data stored with the memory reinforcer to determine a user's situation/state. In one or more embodiments, a Contextual Factor Sensor 206 may be a method or process that executes on a computer system. For example, a Contextual Factor Sensor 206 may be a method that sends messages to retrieve from third-party web service information on contextual factor(s) for a user and/or receives messages from a third-party web service with information on contextual factor(s) for a user. The data or information retrieved with the Contextual Factor Sensor 206 may be stored in a Contextual Factor Database 210 for later retrieval.

A database is any collection of data that may be stored and queried for retrieval of the stored data. Implementations of a database include, but are not limited to, relational databases, object-oriented databases, and file systems. The database may have a database server or a database management system for receiving requests and sending responses to requests for the database, such as query requests. In one or more embodiments, a search engine may be used to query the database. In some embodiments, a query language may be used to query the database and produce a query result. For example, the query language SQL may be used to query a database and produce a query result set. In another embodiment, the data may be stored in a file system and a command may be executed to find or search the data within the file system.

The Memory Reinforcer 208 may use the contextual factors to determine a User's Situation and/or State 212. The User's Situation/State 212 may include one or more contextual factors that may be present and/or past contextual factors for the user. The User's Situation/State 212 may be determined by interpreting one or more contextual factors and setting flags or assigning a value to a variable that indicates the user's state. For example, the memory reinforcer may have obtained a contextual factor from the user's calendaring tool that the user has a meeting scheduled at a location and obtained a contextual factor from the user's client device about the location from the device, and the memory reinforcer may deduce from the location of the user's client device that the user is attending the meeting. A flag may be set that indicates a user is attending a meeting and the system may alter sending reminders to the user accordingly. In another embodiment, a model or simulation of a user may be used to determine the situation/state for the user. Other embodiments may use decision trees, probabilistic reasoning, neural network techniques, genetic algorithms, and logical reasoning to determine the situation/state for the user.

The Memory Reinforcer Module 208 may use a Query Generator Module 214 to generate, create, or produce one or more queries based upon the User's Situation/State 212 and/or one or more contextual factors. The User's Situation/State 212 may determine which queries are generated in order to anticipate information relevant to the user with the given Situation/State. In one or more embodiments, a detected change in one or more contextual factors directly determines the query or queries produced by the Query Generator Module 214. The Query Generator Module 214 may generate a variety of queries for a User Information Database 216 based upon a contextual factor. For example, the Query Generator Module 214 may generate queries to search for reminders or information relevant to a recent change in a contextual factor for the user, and the Query Generator Module 214 may also generate one or more queries for the User Information Database 216 based upon a current date and a current time to determine information for a user with an upcoming due date.

The User Information Database 216 is a collection of data aggregated from one or more information sources for a user. The data stored in the User Information Database 216 for a user is relevant to enhancing the memory of the user. In one or more embodiments, the User Information Database 216 may have reminders for a user. A reminder may be information or data that enables a user to recall or reinforce a memory of a fact, an event, and/or a statement relevant to a user. Metadata may be associated with a reminder in the User Information Database 216 to allow for retrieval of the reminder by querying or searching the database based upon the metadata. Metadata is any data that describes another piece of data. For example, a database may be queried with terms or keywords stored in the metadata for a reminder to retrieve the reminder.

Information sources relied on by the User Information Database 216 may be external, as illustrated with External information Source 220 to the memory reinforcer, and internal to the memory reinforcer, as illustrated with Internal Information Source 218. The data stored in the User Information Database 216 may have data or information that the user may need to recall a memory including, but not limited to, a reminder, a to-do list item, and scheduled meeting information obtained from one or more information sources. The User Information Database 216 may store data from information sources including, but not limited to, calendaring tools, email application and servers, web services, audio and/or video data provided by the user, social networking websites, images, data from web site servers, and text data.

In an embodiment, an information source for the User Information Database 216 may be a Media Clip Database 222. A media clip may be generated from media signals (e.g., audio, video, photographs, text, images) and is selected by the memory assistance server and/or memory reinforcer as being particularly helpful in assisting the user in addressing a particular memory problem. Media clip generation from one or more media signal(s) is described in U.S. patent application Ser. No. 11/560,295, entitled “Memory Assistance System and Method,” filed on Nov. 15, 2006, which is incorporated herein by reference. As detailed in the U.S. patent application Ser. No. 11/560,295 a media clip organizer may generate meta-data and store the meta-data in a manner that enables later searches to be performed based on the key characteristics.

The Query Generator Module 214 may create a variety of queries to retrieve information from the User Information Database 216. The Query Generator Module 214 may use keyword relevance and/or temporal queries in order to retrieve information pertinent to the user based upon the User's Situation/State 212 from the User Information Database 216. For example, when the User Situation/State 212 indicates that the user is attending a meeting, the Query Generator Module 214 may generate a keyword relevance query using a description of the meeting that the user is attending. A keyword relevance query may produce query result with a relevance-ranked text search using keywords. Continuing with the example, the query may produce query result with a relevance ranked text search using keywords from the meeting description, such as meeting participant name(s), locations, and meeting topics. Ranking may be performed by assigning a weight to each query result and ordering the results. The text search may produce query results with any reminder for the user that are relevant to a meeting participant, a location for the meeting, and a meeting topic. In another example, the Query Generator Module 214 may create a temporal query to search the database for any reminder that is close in time to a meeting time that the memory reinforcer has determined the user is attending or plans to attend. A temporal query may be used to search the database for any information associated with a time that is near in time to the time indicated in the query. Continuing with the example, execution of the temporal query for a meeting time may produce any number of reminders that concern a time that is close in time to the meeting time.

The Query Generator Module 214 may create a query to perform a proximity search within the User information Database 216. The Query Generator Module 214 may use the location of the user and a known location for another person to determine if the user is in close proximity to another person or location related to reminder(s) or to-do item(s) for the user. For example, when the user is in close proximity to a grocery store, the Query Generator Module 214 may create a query for all information in the User Information Database 216 relevant to a grocery store, such as to-do items for products to pick up at the grocery store.

The Query Generator Module 214 may create a query to perform a person proximity search with the User Information Database 216. The Query Generator Module 214 may create a query to perform a search within the User Information Database 216 when the user is in close proximity to a person. The Contextual Factor Sensor 206 may determine that a user is near another person or person's device and create a query for all relevant data or information in the User Information Database 216 relevant to the user that involves the person in close proximity to the user. For example, the query result from executing a query against the User Information Database 216 concerning a person in close proximity to the user may have reminders for upcoming meetings scheduled, to-do items, and general facts or notes concerning or associated with the person in close proximity to the user.

The query results returned from executing the queries generated by the Query Generator Module 214 may be provided to a Selection Module 224. The Selection Module 224 may determine what information or reminders may be beneficial for the user to receive. The Selection Module 224 may rank, filter, and/or order the reminders in the query results in order to select the reminders that would be beneficial for the user to receive. In an embodiment, the Selection Module 224 may use a Ranking Module 226 and a Filtering Module 228. For example, the Ranking Module 226 may rank query results based upon their textual relevance to a contextual factor, such as a meeting description attended by a user, and the Filtering Module 228 may select the top three reminders from the ranked reminders from the query results. The Selection Module 224 may repeatedly re-rank, reorder, and filter the reminders from the query result. The Selection Module 224 may use any combinations of various estimators in order to determine the reminders that would be beneficial for the user to receive. An estimator provides an estimation or educated guess as to the information that would be beneficial for the user.

The Selection Module 224 may rely on a Forgetting Estimator 230 to rank and/or filter the query results. The Forgetting Estimator 230 may estimate the relative strength of a memory for the user represented by each reminder. The Forgetting Estimator 230 may determine which reminders are stronger or weaker in memory for a user based upon how quickly a person forgets over time. The Forgetting Estimator 230 may factor in the overload that the user is experiencing and the attention that the user gave the information when the information was last presented to the user. The Forgetting Estimator 230 may request information on when a user has last seen a reminder from a Data Interaction Database 232 that tracks information on reminders that the user has seen. The Forgetting Estimator 230 may maintain a forgetting curve for each reminder.

In one or more embodiments, the Forgetting Estimator 230 may rely on a variation of an Ebbinghaus forgetting curve, which provides a rate at which people forget information over time. FIG. 2b illustrates an exemplary graph of a forgetting curve for an implementation of memory augmentation. FIG. 2b provides a graph with the following data based upon Ebbinghaus' research:

| Hours | Strength |
|---|---|
| 0 | 1 |
| 0.333333 | 0.582 |
| 1 | 0.442 |
| 9 | 0.358 |
| 24 | 0.337 |
| 48 | 0.278 |
| 144 | 0.254 |
| 744 | 0.211 |

where the y-axis is “retention” and the x-axis is “time (in hours).”

The data from the Ebbinghaus forgetting curve may be used to create a mathematical equation or function that is a variation or an approximation of an Ebbinghaus forgetting curve. In an embodiment, the approximation of the Ebbinghaus forgetting curve may be a piecewise linear mathematical function. The mathematical function may give an estimate for the strength of a reminder or piece of information in the user's memory at a moment in time. Equations may be derived from empirical evidence of one's ability to recall a particular piece of information, such as empirical evidence found by Ebbinghaus. An example of a mathematical equation that is an approximation of an Ebbinghaus forgetting curve is, as follows:

$$\begin{matrix}Strength = 1.0 - 1.254 \times hours & if hours < 0.333 \\ = 0.652 - 0.21 \times hours & if hours \geq 0.333 and \\ & hours < 1.0 \\ = 0.4525 - 0.0105 \times hours & if hours \geq 1.0 and \\ & hours < 9.0 \\ = 0.3706 - 0.0014 \times hours & if hours \geq 9.0 and \\ & hours < 24.0 \\ = 0.396 - 0.0024583 \times hours & if hours \geq 24.0 and \\ & hours < 48.0 \\ = 0.29 - 0.00024 \times hours & if hours \geq 48.0 and \\ & hours < 144.0 \\ = 664067 \div ( {hours}^{2} + 2593701 ) & if hours \geq 144.0 \\ ( where time is measured in hours ) . & \end{matrix}$$

The equation may provide a strength for a particular memory that is a value between 0.0 and 1.0, where 0.0 means an estimate of no recollection or ability to recall the particular memory and 1.0 means an estimate of perfect recollection or ability to recall the particular memory. In one or more embodiments, the equation may ensure that a strength for a particular memory monotonically decreases as time passes, a strength remains positive, and/or a strength does not have a zero value. The equations can be modified to be personalized for the user to account for ailments or impediments that the user may be experiencing.

In one or more embodiments, the equation may account for how recently the user has been presented information regarding a particular memory. For example, the user's memory may have been reinforced by the presentation of information regarding a reminder for a particular memory. The reinforcement of a particular memory may increase the strength of the particular memory for the user and decrease the rate of decay for the strength of the particular memory. The increase in strength of the particular memory and the decrease in decay may depend on the presentation of information from a reminder and the amount of attention the user gave to the information from the reminder. For example, the presentation of information from a reminder using a loud audio presentation may result in a greater increase in the strength of a particular memory and a lower rate of decay than the respective values for a softer audio presentation. Each time a user sees, hears, or consumes the information for a particular memory, the particular memory may be strengthened for the user. The repetition of presentation of information regarding a particular memory may also result in a decrease in the rate of memory strength decay. As such, an example of how the above equations may be adjusted is, as follows:

$$\begin{matrix}Strength = 1.0 - 1.254 \times & if ( hours \div decay ) < 0.333 \\ ( hours \div decay ) & \\ = 0.652 - 0.21 \times & if ( hours \div decay ) \geq 0.333 \\ ( hours \div decay ) & and ( hours \div decay ) < 1.0 ; \\ = 0.4525 - 0.0105 \times & if ( hours \div decay ) \geq 1.0 \\ ( hours \div decay ) & and ( hours \div decay ) < 9.0 ; \\ = 0.3706 - 0.0014 \times & if ( hours \div decay ) \geq 9.0 \\ ( hours \div decay ) & and ( hours \div decay ) < 24.0 ; \\ = 0.396 - 0.0024583 \times & if ( hours \div decay ) \geq 24.0 \\ ( hours \div decay ) & and ( hours \div decay ) < 48.0 \\ = 0.29 - 0.00024 \times & if ( hours \div decay ) \geq 48.0 \\ ( hours \div decay ) & and ( hours \div decay ) < 144.0 ; \\ = 664067 \div & if ( hours \div decay ) \geq 144.0 ; \\ ( {( hours \div decay )}^{2} + 2593701 ) & \\ ( \begin{matrix}where the default decay \\ rate is 1.0 and decay > 0.0\end{matrix} ) . & \end{matrix}$$

A smaller decay rate may indicate that the particular memory fades slower whereas a larger decay rate may indicate that the particular memory fades faster. As the user is repeatedly presented with information about the particular memory, the decay rate is gradually decreased. The decay rate may be increased if there is information indicating the user has either a temporary or permanent memory ailment or impediment. For example, each presentation of the information for a reminder may decrease the value of decay rate and consumption of alcohol, age, and ailments or impediments (e.g. amnesia, Alzheimer's, age of user) may increase the decay rate.

In one or more embodiments, the equation may factor in the repeated exposure to information from a reminder. Each exposure may result in a decrease in the rate of memory strength decay. For example, the following equation factors in repeated exposure to the information:

decayₙ₊₁=decayₙ×Cₙ×Fₙ

(where n is the nth consumption in a sequence of consumption or repeated exposure to information for the reminder). In a preferred embodiment, the decay rate may be reduced by 5% for each full attention re-exposure that the user gave to the information and a fraction of 5% reduction in the decay rate occurs when less than full attention is given by the user to re-exposure to the information. The decay value may also be increased when it is determined that the user has a temporary or permanent ailment or impediment.

In one or more embodiments, the equation may factor in how attentive the user was in consuming the information when the user was last presented with the information about a reminder and/or whether the user had no impairment to their biological memory faculties. An example of an adjusted equation to account for these factors is, as follows:

$$\begin{matrix}Strength = CxFx ( 1.0 - 1.254 \times & if ( hours \div decay ) < 0.333 \\ ( hours \div decay ) ) & \\ = CxFx ( 0.652 - 0.21 \times & if ( hours \div decay ) \geq 0.333 \\ ( hours \div decay ) ) & and ( hours \div decay ) < 1.0 ; \\ = CxFx ( 0.4525 - 0.0105 \times & if ( hours \div decay ) \geq 1.0 \\ ( hours \div decay ) ) & and ( hours \div decay ) < 9.0 ; \\ = CxFx ( 0.3706 - 0.0014 \times & if ( hours \div decay ) \geq 9.0 \\ ( hours \div decay ) ) & and ( hours \div decay ) < 24.0 ; \\ = CxFx ( 0.396 - 0.0024583 \times & if ( hours \div decay ) \geq 24.0 \\ ( hours \div decay ) ) & and ( hours \div decay ) < 48.0 \\ = CxFx ( 0.29 - 0.00024 \times & if ( hours \div decay ) \geq 48.0 \\ ( hours \div decay ) ) & and ( hours \div decay ) < 144.0 ; \\ = CxFx ( 664067 \div & if ( hours \div decay ) \geq 144.0 ; \\ ( \begin{matrix}{( hours \div decay )}^{2} + \\ 2593701\end{matrix} ) & \\ ( \begin{matrix}where the default decay \\ rate is 1.0 and decay > 0.0\end{matrix} ) . & \end{matrix}$$

(where C=Strength of consumption [0.0-1.0] and F=Correction for any temporary or permanent memory dysfunctions leading to altered ability to store or retain a particular memory). The variable for strength of consumption may allow for factoring in how the information was consumed by the user. For example, the strength of consumption variable may indicate whether a user used the information or just consumed it (e.g. whether a user wrote an email with the information vs. read an email with the information). Other examples may include, but are not limited to factoring in how distracted the user may have been during, consumption, whether the information was presented by itself or alongside information, and whether there were any measures taken to draw the user to the information. The variable for a correction for memory dysfunction may have a value of 1.0 for users with normal memory function in above equation. Examples of cases where memory dysfunction may be factored include, but are not limited to, an elevated blood-alcohol level, hippocampus damage resulting in a reduced ability to form long-term memories in their brain, and Alzheimer's disease.

Although an implementation is described in reference to the use of the data from the Ebbinghaus forgetting curve, those skilled in the art will recognize that the Forgetting Estimator 230 may be implemented with alternative algorithms.

In an embodiment, the Forgetting Estimator 230 may personalize the rate at which a person forgets by incorporating in factors that may affect the user, such as age, effect of alcohol consumption, particular ailments, and/or any other type of memory inhibitor. For example, if a user is suffering from an ailment, such as a common cold, the user may request that the Forgetting Estimator 230 factor in the effects of the common cold on their ability to recall information for a period of time. A variety of sensors may be used to determine both contextual factors and help personalize the system for the user, including, but not limited to, blood-glucose sensors, heart-rate sensors, galvanic skin sensors, blood/alcohol sensors, breathalyzers, eye-tracking devices, blink/rate sensors, sensors that detect fatigue, slouch detectors, voice volume detector, and any other devices that track one's sleep patterns or activities. Those skilled in the art will recognize that there are many factors that may concern a user and can be incorporated to personalize a forgetting estimate for the user. An example of an Ebbinghaus forgetting curve is provided in Contribution to Experimental Psychology (1885) by Hermann Ebbinghaus and translated by Henry Alford Ruger, Clara E. Bussenius, published by Teachers College, Columbia University, 1913.

The Selection Module 224 may rely on an Attention Estimator 234 to rank and/or filter the query results. The Attention Estimator 234 may estimate a user's attention for various topics, keywords, or a particular reminder. The Attention Estimator 234 may use contextual factors and sensors, eye-trackers, a user's input to system regarding topic(s) of interest, or devices to observe the length of time a particular piece of information appears on the screen to determine a topic of interest for a user. The Attention Estimator 234 may rank and/or filter reminders based upon an estimate of a user's attention for a reminder based upon factors including, but not limited to, when the user has seen the reminder or topic previously, how often the reminder or topic has been seen, and the amount of time viewing the reminder. The Attention Estimator 234 may access the Data Interaction Database 232 to retrieve information on a user's interaction with information from a reminder. For example, an eye tracker may determine what information the user is looking at or listening to and the interaction between the user and the information on the screen may be stored in the Data Interaction Database 232.

The Selection Module 224 may rely on a Repetition Estimator Module 236 to determine when reminders may be delivered to maximize long-term memory retention. The Repetition Estimator Module 236 may be implemented using a spaced interval repetition algorithm. The Repetition Estimator Module 236 may determine which reminders are delivered at even or uneven intervals of time to maximize long-term memory retention. For example, it may be beneficial to provide a reminder to a user after 2 days, 6 days, and then, after 30 days. Regardless as to whether a due date is assigned by a user (user-scheduled reminder) or the system has received any other information about when a user would like a reminder (system-scheduled reminder), a reminder may be put on a reminder repetition schedule. In one or more embodiments, the reminder repetition schedule may specify the times when reminders may be delivered to reinforce or help a user recall a particular memory. The reminder repetition schedule may be created based on what the system can determine about the time the user first consumed or viewed the information within the reminder. Initially, the time the user first consumed the reminder may be the time that the user created the reminder, first read, or otherwise consumed the information. In one or more embodiments, the time the user first consumed the reminder may be the time it was stored on a device, with a service, and/or imported to the system. For example, if the reminder is a photograph, the “start time” is the time the user took the photo.

Embodiments may determine a repetition pattern for scheduling the reminders to be received by a user. In an embodiment, the repetition pattern may be determined based upon a memory strength threshold. For example, a reminder may be scheduled to be sent to a user when memory strength first goes below 0.278, then when it first goes below 0.254, and then when it first goes below 0.211. Each time a user consumes a reminder, the user's memory strength estimate may be increased. In the present example, the Repetition Estimate Module 236 may wait for the strength to decrease to the next threshold, and then suggest that the user be sent the reminder until no more thresholds are scheduled for the reminder. For example, if the user has no additional interactions, views, or consumptions of a reminder after the initial creation or consumption, it may be assumed that the user gave full their attention (C=1.0) at the initial creation or consumption time and assuming the user has no temporary or permanent memory predispositions (F=1.0), the repetition pattern resulting from [0.278, 0.254, 0.211] may be approximately 2, 7, and 31 days (corresponding to Ebbinghaus' forgetting curve).

In one or more embodiments, a user may interact with the reminders associated with the user and/or user's account in the system by performing actions on the reminders (e.g., editing title, mark a to-do item as complete, changing, adding, or removing a due date). Each of these interactions may reinforce the reminder in the user's memory and may alter the user's memory strength and/or decay rates. The memory strengthening due to the interaction may occur for a user at a time that is close in time (e.g. within 1-2 days) to the next scheduled sending of a reminder to the user and the scheduled reminder in the repetition reminder schedule may be removed. If a reminder is deleted or marked as complete, it may be removed from the repetition reminder schedule. If a user explicitly specifies a reminder should be removed from repetition reminder schedule, then the schedule may be terminated but the reminder may not be removed. Similarly, the user may restore the reminder to ensure that the reminder be placed back in the repetition reminder schedule. The repetition reminder schedule may take into account a user's typical waking hours for receipt of reminders and ensure that the reminder arrives within those hours. The user's typical waking hours may be defined by the user or by default (e.g., 7 am-11 pm) and may account for the user's current time zone. A user's time zone may be determined by obtaining data from the contextual factors about the user's current location. For example, information obtained from GPS, or a mobile phone may provide the system with a current time of day at the location of the nearest cell tower as provided by a mobile phone provider's network.

The Repetition Estimator Module 236 may compare the repetition reminder schedule for a reminder with the due dates for the user-scheduled reminder or system-scheduled reminder. If a reminder has a user-scheduled reminder or system-scheduled reminder that is prior to a scheduled due date (e.g., remind me 15 minutes before this is due), the repetition reminder schedule may be adjusted to accommodate the user-scheduled reminder or system-scheduled reminder. For example, if a repetition reminder is anticipated to be close in time to the user-scheduled or system-scheduled time (e.g., 1-2 days before or after), the reminder sending time may be adjusted in time to better strengthen the memory prior to the due date, factoring in the user-scheduled scheduled reminder or system-scheduled scheduled reminder. One example of rescheduling is to schedule 24 hours prior to the due date (optionally, adjusting for waking hours). Another example is to take the time interval (in hours) between the user- or system-scheduled reminder and the due date, multiply it by a multiplicative factor, and reschedule the interval reminder for that time (optionally, adjusting for waking hours). In a preferred embodiment, the multiplicative factor may adjust the time for the rescheduled time that may be found by users to be a preferred amount of time to receive a reminder. For example, a maximum time may be factored in with rescheduled reminder time=due time−max (24 hours, (due time−user- or system-reminder time)*16), (where 16 is the multiplicative factor), if rescheduled reminder time is within waking hours, use that time; if not, round the rescheduled reminder time to the nearest “awake” time>the current time. Another example may replace the multiplicative factor with a computation based on memory strength.

The repetition reminder schedule may be adjusted so that the reminder delivery time is determined based on an apt time to receive a reminder for a user. This may be determined by reviewing a user's calendar to identify free times in the user's schedule or other contextual factors to determine that the user's overload estimate, as provided by the Overload Estimator Module 238, is low. For example, the Repetition Estimator Module 236 may take into account the total number of reminders scheduled within the 24 hours leading up to the due date and space reminders to be sent at even intervals and/or it may cluster related reminders (e.g., by looking at textual relevance, tags) so that related reminders come together or closely separated in time (e.g., in a single message or within seconds or minutes of one another).

After the last scheduled threshold has been reached on the repetition reminder schedule, the reminder may still be delivered to the user. The Repetition Estimator Module 236 may still periodically choose to deliver such a reminder or develop a new schedule for the reminder. The following criteria may factor into a decision to develop a new repetition reminder schedule for a reminder: reminder is not on an explicit repetition schedule, reminder has an explicit due date in the future, and/or the reminder is not designated as completed. The Ranking Module 236 may order the reminders by: increasing or decreasing memory strength for the reminder, near or distant due dates, clustered by similarity to others in the list (e.g., two reminders about “baseball” are organized in the presentation next to each other), relevance to other items if these items are part of a larger reminder presentation (e.g., if this is part of a daily summary email with various reminders, if some of the items are more-related to other items in the presentations). Related reminders can be determined by textual similarity, topic, tags that annotate the item, proximity in time (e.g. two items that were created close in time to one another), and proximity in space (e.g., two items that were created near the same physical location), or any combination thereof.

The Repetition Estimator Module 236 may retrieve data in the Data Interaction Database 232 to determine an estimate, including, but not limited to, what has been seen by a user, what has been delivered to a user, and how the user has adapted to the timing of repeated exposure to a reminder. The Repetition Estimator Module 236 and Selection Module 224 may factor in an overall information overload that the user may be experiencing.

An Overload Estimator Module 238 may be used to ensure there is a balance between the amount of information that may be received by the user to maximize retention and the amount of information that a user can consume or tolerate. The Repetition Estimator Module 236 may factor in the amount and content of information consumed by the user to ensure that a single piece of information is not repeatedly presented in a short time span, and instead, that a majority of information may be presented relative to the priority or importance of the information.

The Overload Estimator Module 238 may ensure that a user is not overloaded with information by creating a threshold number or amount of information that a user can receive. In a preferred embodiment, the Overload Estimator Module 238 may set the threshold to three when the user is receiving text reminders. The Overload Estimator Module 238 may filter, reorder, determine communication channels for reminders, trim, or curtail a list of reminders based upon one or more contextual factors of a user. For example, the Overload Estimator Module 238 may determine that a user is overloaded due to a busy calendar, close proximity to a person, current use of another application, engaged in an activity, or an emotional state. For example, the Overload Estimator Module 238 may use input from the Attention Estimator Module, information on vocal patterns, information on the ambient sound for the location, location sensors, and motion detection sensors. The Overload Estimator 238 may determine that a user is engaged in an activity, such as exercising, driving, reading, writing, and/or talking as observed by the contextual factors. The Overload Estimator Module 238 may also be used to determine the presentation of reminders to the user.

The Overload Estimator Module 238 may estimate the amount of information and attention load a user is experiencing. The overload estimation provided by the Overload Estimator Module 238 may then be used to adjust what information is selected and presented to the user. For example, if the user is under heavy load, the system can reduce the number of items to present and visually emphasize the remaining ones; or if the user is under light load, the system can choose to present more information. Load may be expressed as a number where a higher value represents higher load. In an embodiment, 0.0 is completely unloaded, 1.0 is full capacity, and numbers greater than 1.0 represent overload. The Overload Estimator Module 238 may base its' assessment on information acquired with the contextual factors. For example, the Overload Estimator Module 238 can examine the user's calendar and determine if the user is in a scheduled meeting at the current time and compute the percentage of free time the user has in a given day. Other factors can contribute to the load estimate. For example, if the user is speaking, then a full load (1.0) may be assigned for the user. The Overload Estimator Module 238 can determine if a person is speaking by positioning a microphone close to a user and detecting high volume levels. Additional disambiguation can be done using “speaker identification” and “speaker verification” technologies that analyze an audio signal to determine who is speaking (speaker identification) or determining the probability that a particular person is speaking (speaker verification). Those skilled in the art will recognize that there are a variety of implementation that can be used to perform speaker identification and speaker verification.

In another example, the Overload Estimator Module 238 may determine if a user is driving. Determining if a user is driving can done by using a location sensor to determine if a person is in motion, on a road, or traveling at automobile speeds (e.g., faster than walking or bicycling and slower than flying). Using a combination of GPS and maps, a deduction can be made to determine if a person is in a car and in motion. For example, load may be high when in motion (1.0) and lower when stopped (0.5).

In another embodiment, the Overload Estimator Module 238 load estimation may be done by examining communication traffic for the user, such as telephone calls, email, SMS, and other forms of communication on a mobile phone. Talking may be defined to have a higher load than listening and an example computation of load based on communication may take the form of a weighted average of all communications. For example, communication load=(30×Outbound communications/minute+inbound communications/minute)

In another example, the Overload Estimator Module 238 load estimation may be done by examining biometric signals. For example, examining one's heart rate and galvanic skin response may indicate the user is engaged in physical activity. Various examples of detectable activities include, but are not limited to: talking, listening, reading, writing, participation in a meeting, driving, and athletics. In one or more embodiments, a fixed “load” value for each activity may be assigned and then computing a weighted average of the load of that activity with the probability that activity is happening. An example of an equation for such assignment is, as follows:

$${\sum }_{i = 1}^{n} {a}_{i} * {p}_{i}$$

(where “a” is the fixed “load value” for the activity and “p” is the probability the user is engaging in that activity. “n” is the total number of activities the system is currently designed to detect. As a probability, “p” may range from 0.0 to 1.0 and may be computed by each individual activity detector (e.g., an email reading activity detector would produce an estimate for its' “p” value as would a speaking detector).

A Presentation Logic Module 240 may utilize estimates from the Overload Estimator Module 238 to determine and/or adjust the presentation of reminders or amount of reminders to a user. The Presentation Logic Module 240 may determine the appropriate presentation of reminders to a user in accordance with the User's Situation/State 212. The Presentation Logic Module 240 may determine and/or adjust many aspects of the presentation of reminders, including, but not limited to, communication channel, number of communication channels used for presentation to the user, style in which reminders are presented, amount of information from a reminder received, volume, font, size, color, visual, sound, touch, or any combination thereof. The Presentation Logic Module 240 may use one or more contextual factors to adjust the presentation of reminders. For example, the contextual factors may indicate whether the user is busy or not busy, whether the user is currently using a software application, and the location of the user, and the presentation may be adjusted accordingly. The Presentation Logic Module 240 may factor in the relevance of the reminder and the attention that user may give the reminder as indicated by the Attention Estimator Module 234 in order to determine the appropriate presentation to the user. For example, information from a reminder that is particularly relevant to the user may be sent to multiple communication channels and may be verbally communicated to the user at a higher volume than a less relevant reminder.

The Presentation Logic Module 240 may improve the content and the appropriateness of reminders provided to a user in accordance with a user's situation/state. In one or more embodiments, the Presentation Logic Module 240 may use a Presentation Machine Learning Module 242 to learn over time how to improve the content and appropriateness of reminders for the situation/state. The Presentation Machine Learning Module 242 may gauge the quality and appropriateness of a reminder by explicitly requesting the opinion of the user after a reminder is received and/or observing the reaction of the user to the receipt of the information and/or ability to recall the information. For example, the Presentation Machine Learning Module 242 may explicitly ask the user whether the person forgot the contents of a reminder and/or monitor how long a user viewed a reminder or reminders on a particular topic. In one or more embodiments, the Presentation Machine Learning Module 242 may indicate the types of reminders that are beneficial to the user and the types of reminders that are determined to be beneficial may be used to rank/filter reminders with the Selection Module 224. The Presentation Logic Module 240 may consider the environment that the user is in and alter the type of presentation for the communication channel. For example, the system may send a verbal communication through the phone (e.g., a whisper reminder over phone), email or vibrate the phone to communicate that a user should become aware of a reminder when the user is at a meeting. The Presentation Logic Module 240 may alter the verbosity of a reminder. For example, the Presentation Logic Module 240 may shorten the reminder to have three bullet points from five bullet points depending on the User's Situation/State 212. Other examples include, but are not limited to, summarizing reminders, reducing the number of words or letters in reminders, and optimizing the speed of presentation of portions of the reminders with the use of Rapid Serial Visual Presentation (RSVP). An example of RSVP may be found in “Visual perception of rapidly presented text segments of varying complexity” by Forster, K. L., 1970, Perception and Psychophysics, 8, 215-221.

The Presentation Logic Module 240 may use various communication methods to communicate the reminders to the user and the Presentation Logic Module 240 may be used to determine the appropriate communication channel to be used in accordance with the user's situation/state. The reminders can be presented to the user over communication channels in formats including, but not limited to, email, Short Message Service (SMS) messages, Multimedia Messaging Service (MMS) messages, phone calls, a web or news feed (e.g., RSS feeds), iCal feeds, messages sent through any third-party service, messages sent by software (e.g., alerts sent by calendaring software) and instant messaging. The reminders may also be presented to the user through a web site or software application, such as, an update to a user's calendar and/or posting information to a social networking site. The presentation aspects may be personalized for the user and the user may request how, preferences for, and what communication channel to use to communicate reminders to the user.

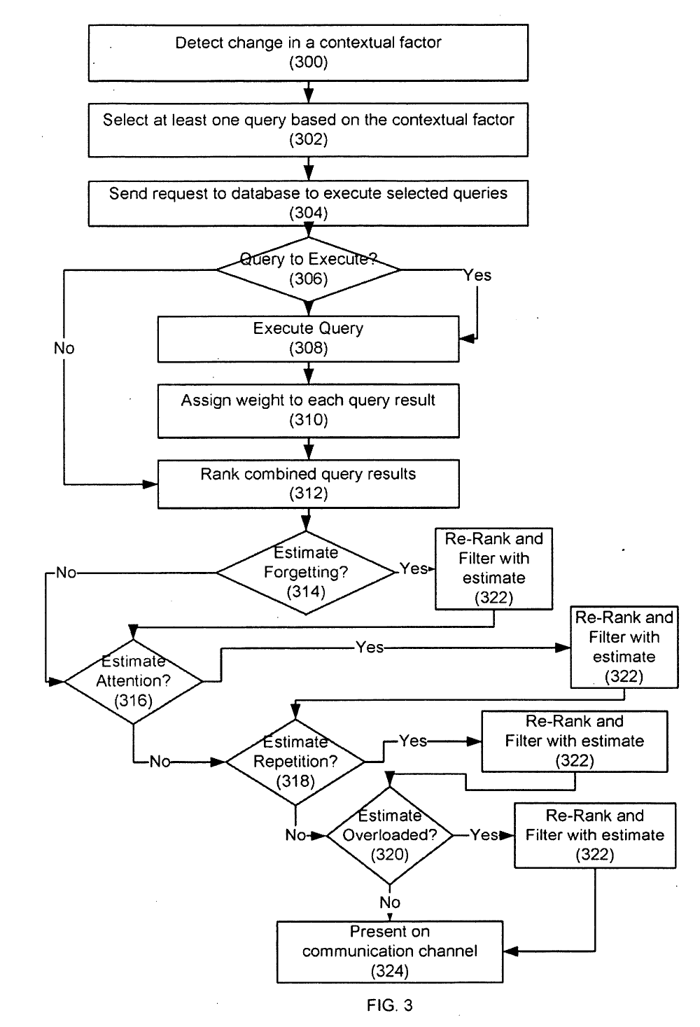

FIG. 3 illustrates an exemplary flowchart for an implementation of memory augmentation. Initially, a contextual factor may be detected (300). For example, the contextual factor of location information for a user may be obtained from a user's device. The contextual factor may be determined with a contextual factor sensor, as described in the description of FIG. 2. Continuing with the location information example of a contextual factor, the location information may be obtained from a GPS location receiver in the user's device. The GPS coordinates from the device may be uploaded from the device to the memory reinforcer server. Location may also be determined from a cell tower, and/or a Wi-Fi™ access point.

At least one query may be selected based upon the contextual factor (302). Queries may be selected that obtain relevant reminders from a database with the obtained location information. For example, a query that is based upon the location information may select all reminders that pertain to a location in close proximity to the obtained location information for the user.

A request may then be sent to the database to execute each of the selected queries (304, 306). After execution of each query (308), a weight may be assigned to each of the reminders in the query results (310). A weight may be assigned by associating a numerical value with a reminder. For example, the weight may be assigned based upon the textual relevance of a reminder to a keyword used in a query or upon the closeness in proximity of a location mentioned in a reminder to the obtained location information from a contextual factor sensor. The query results for each of the queries may be combined and the weights for the same reminders may be combined to for a single numerical value for the reminder (312). The reminders may be ranked (312) in accordance with their respective weights.

Next, a determination may be made to obtain a forgetting estimate (314). If a forgetting estimation is desired, then an estimation of the relative strength of a memory represented by a reminder is determined and the reminders may be re-ranked and/or filtered in accordance with the estimation (322). Alternatively, a forgetting estimate may not be desired (314).

Continuing with FIG. 3, a determination may be made to obtain an attention estimate (316). If attention estimation is desired, then an estimation of a user's attention for a particular memory represented by a reminder is determined and the reminders may be re-ranked and/or filtered in accordance with the estimation (322). Alternatively, an attention estimate may not be desired (316).

Continuing with FIG. 3, a determination may be made to obtain a repetition estimate (318). If repetition estimation is desired, then an estimation of how often a reminder should be presented to ensure maximum retention for the reminder is determined and the reminders may be re-ranked and/or filtered in accordance with the estimation (322). Alternatively, a repetition estimate may not be desired (318).

Continuing with FIG. 3, a determination may be made to obtain an overload estimate (320). If overload estimation is desired, then an estimation of a threshold for the user in receiving reminders is determined and the reminders may be re-ranked and/or filtered in accordance with the estimation (322). Alternatively, an overload estimate may not be desired (320). Continuing with FIG. 3, information from the reminders may be presented to the user on a communication channel (324).

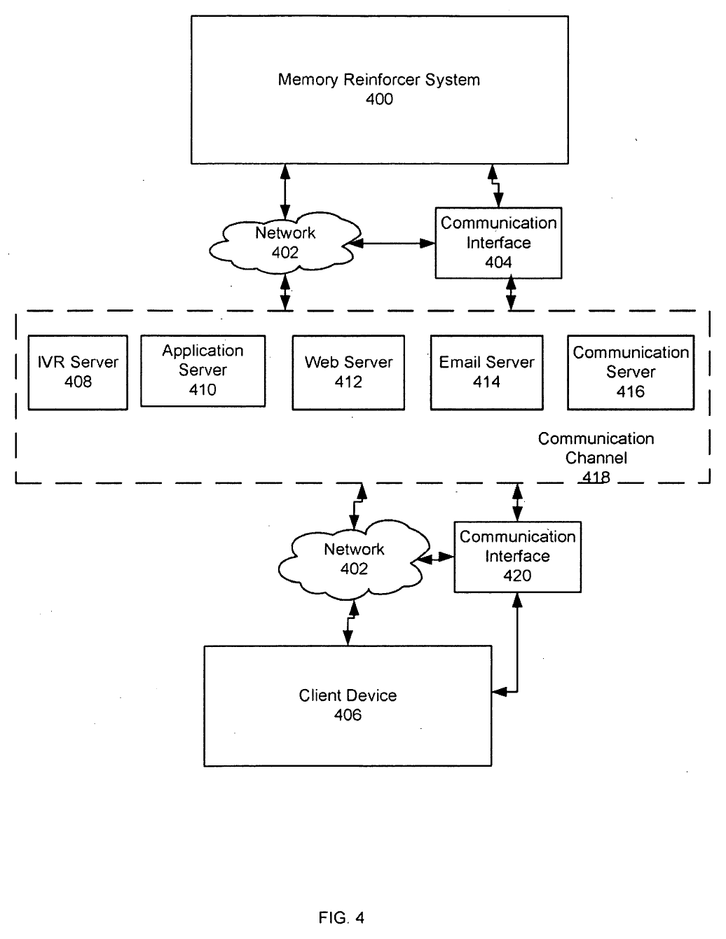

FIG. 4 illustrates an exemplary block diagram for an implementation of memory augmentation. As illustrated in FIG. 4, Memory Reinforcement System 400 may use a Communication Interface 404 to communicate data or information over a Network 402 or directly with a Client Device 406. In one or more embodiments, a Client Device 406 may use a different Communication Interface 420 to communication with the Memory Reinforcement System 400. The Memory Reinforcement System 400 may use the Communication Interface 404 to communication with one or more servers, such as an interactive voice response (IVR) server 408, an Application Server 410, a Web Server 412, an Email Server 414, Instant Message servers, or any other type of Communication Server 416. Each of the servers and communication interfaces represents an example of a Communication Channel 418 that may be used to present information from reminders to a user. Communication Channels 418 may be communication servers and/or interfaces that provide support for the following, but not limited to, SMS, instant messages, RSS feeds, text messages, icons, earcons, or any other type of communication. Icons and earcons may be informational decorations that may decorate a message and/or be content bearing to indicate information to the user. Those skilled in the art will recognize that there are a variety of communication interfaces that may be employed to facilitate communication between the Memory Reinforcement System 400 and the Client Device 406.

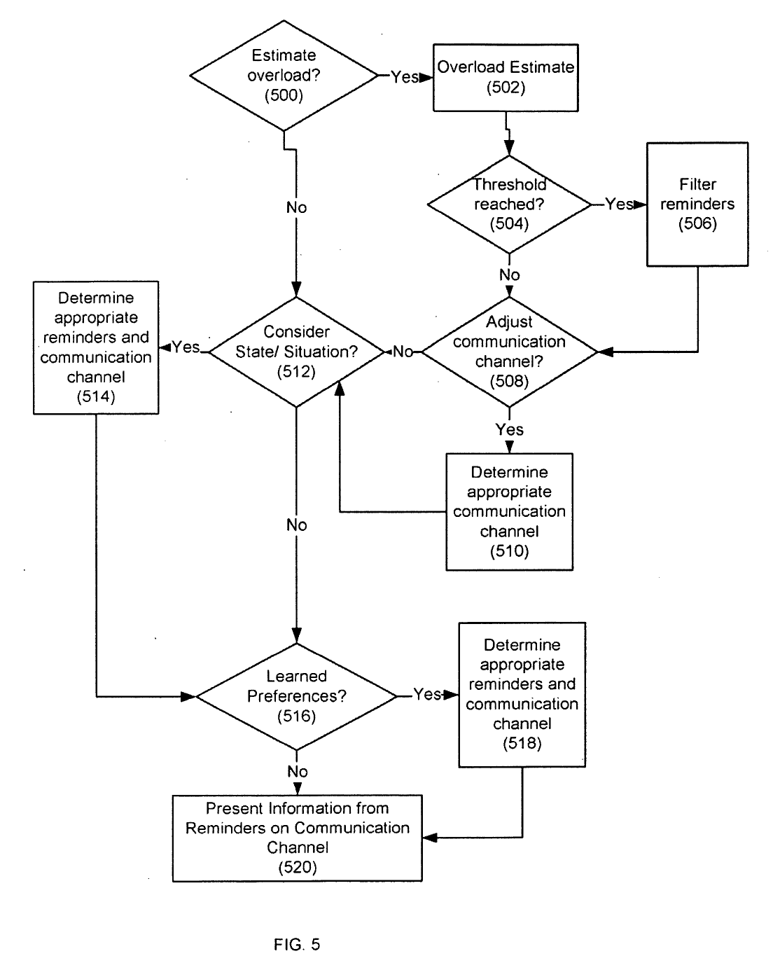

FIG. 5 illustrates an exemplary flowchart for an implementation of presentation logic for memory augmentation. Presentation logic may determine the information from selected reminders that will be presented to the user and the communication channel chosen to present the information to the user in accordance with the user's situation/state. Initially, a determination may be made to obtain an overload estimate (500) and an overload estimation of a threshold for the user in receiving reminders is determined (502). The threshold may be used to determine a number of reminders that the user may be capable of receiving. Alternatively, a determination may be made to refrain from obtaining an overload estimate (500) and a determination may be made as to whether to consider a user's situation/state in presentation of selected reminders to the user (512).

Continuing with FIG. 5, if the number of selected reminders causes a threshold to be reached for the user (504), then the reminders are filtered (506). Filtering may entail reducing the number of selected reminders to be presented or the information presented to the user from the reminders. The selected reminders with the lower rank may be the first reminders removed from the selected reminders to present to the user. Next, a determination may be made as to whether to adjust the communication channel. Alternatively, a threshold may not have been reached for the user (504) and a determination may be made as to whether to adjust the communication channel (508).

Continuing with FIG. 5, a determination may be made to adjust the communication channel (508) based upon the overload estimation and the appropriate communication channel may be determined for the user (510). For example, the overload estimation may indicate the number of selected reminders to present to the user is close to a threshold value for the user aid the communication channel may be adjusted to send an email as opposed to a text message. The presentation logic may also adjust the content, verbosity, number of communication channels for presentation to the user, and style for the presentation to the user. Next, a determination may be made as to whether to consider the user's situation/state (512). Alternatively, a determination may not be made to adjust the communication channel (508) and a determination may be made as to whether to consider the user's situation/state (512).

Continuing with FIG. 5, a determination may be made to consider a user's situation/state (512). If a user's situation/state is considered, then a determination may be made to as to what the appropriate reminders and communication channel are for the user's situation/state. For example, a text message may be preferred to immediately communicate reminders for an upcoming meeting and the amount of information from reminders presented may be reduced to ensure that the message is under a character limit for a text message. Next, a determination may be made as to whether to consider learned preferences for a user (516). Alternatively a user's state/situation may not be considered (512), and a determination may be made as to whether to consider learned preferences for a user (516).

Continuing with FIG. 5, a determination may be made to consider a user's learned preferences (516). If a user's learned preferences are considered, then a determination may be made to as to what the appropriate reminders and communication channel in accordance with learned preferences (518). For example, a user may requested only email reminders be sent and email will be used as a communication channel for the user. Next, information from the reminders is presented to the user on a selected communication channel (520). Alternatively learned preferences may not be considered (516) and information from the reminders is presented to the user on selected communication channel (520).

In one or more embodiments, a location sensor may be used by the system to identify relevant reminders to support a user's memory recall and memory reinforcement. A user may associate a reminder to a location, thereby indicating that the user wishes to be reminded of the reminder when they are near that location. When the user is near to the location, the user may be presented with the reminders that were associated with that location (e.g., the user is at work and the system presents reminders the user wanted to be reminded of when the user was at work). Another example of using location to determine relevance of content and provide memory augmentation using location is to present items to the user (or someone else) that were created near the user's present location. An example scenario is, as follows: a user visits a restaurant and creates items about likes or dislikes for the restaurant and menu while the user is in the restaurant, and the user returns and the items created previously are presented.

In another example, a user records or creates reminders to remember when the user is at work and not at home. The user may associate these reminders with the user's work location, but the system may notice that the user is often at home and often creates reminders at home. The system may then attempt to determine relevance of a reminder to a location even if that reminder has not been associated with that particular location by looking at the frequency a user visits that particular location. For example, the more frequently the user is at a given location, the less relevant the location that the user created the reminder in may factor in the overall ranking of the reminder as relevant to that location.

The contextual factor sensors may provide the user's location information and a history of the user's location information may be stored in a database. The frequency that a user visits a location (frequency information) may be used to filter and rank the reminders presented to the user. For example, historical location information and frequency information for a particular location may be computed for the user. To compute this information, the number of stored times that the user has been near the particular location can be used. Various ways to count visits include, but are not limited to: number of separate hours where the user was previously near this location at least once during a given hour, number of separate days where the user was previously near this location at least once during the given day, number of separate weeks where the user was previously near this location at least once, and number of separate months where the user was previously near this location at least once. Normalization of the data may prevent bias that might be introduced by having many visits to a location in a short span.

An example of normalizing the data is designating a single visit as a contiguous block of time where the user was near a location and did not leave that location. The visit for the user may begin when the user first came near the location and the visit may end when the user first becomes not near that location. For example, a five-day visit to a mountain cabin where the user never left the cabin would be considered one visit and three separate trips to the market on a given day would count as three. In another example, if the data indicates the user is at a location one day per month, the data suggests that the user infrequently goes to this location. Whereas if a user is at a location three days per week, the data may suggest a user more frequently visits a location. In a preferred embodiment, the number of days in the last 90 days where at least one visit took place is used to determine location frequency with the following equation, Location frequency=(number days in the previous 90 days where the user was near that location sometime during each of those 90 days)/90. The location frequency information may be used to determine the number of items to present to the user. For example, ten items may be selected to present to the user if the location frequency<0.1 and 9 items may be selected if 0.1<=location frequency<0.2 and so on.

In one or more embodiments, the ranking of items may be determined by one or more of the following factors: distance, memory strength and/or content relevance. For example, the items may be ranked in accordance with how close the current user's location is to the item's location (either where it was created or where it was assigned). One way of computing distance relevance is, as follows: 1/(t+1) where t=distance in kilometers (where distance relevance is computed as a value between 0.0 and 1.0 where 1.0 is maximum relevance and 0.0 is no relevance). Items with the weakest memory strength may be ordered earlier than items with stronger memory strength. An example equation to determine a memory strength relevance is, as follows: (1—memory strength).

In another example, the name of the location may have been provided by the user or may be determined from a third-party Geographic Information Service (GIS). For example, GIS systems may convert latitude and longitude coordinates to Country, State, City, and Street. A GIS system may also be able to identify words, such as the name of a store or the owners of a house and the words may then be used to construct a query that is used to search the text of the items created at this location.

In one or more embodiments, the overall relevance may be computed for an item or reminder that produces a value for each reminder and the reminders may then be ranked in accordance with the value associated with the reminder. The overall relevance of a reminder or item may factor in distance relevance, memory relevance, content relevance, or any combination thereof. An example of an equation to compute overall relevance is overall relevance of item n=A×(distance relevanceₙ)+B×(memory relevanceₙ)+C×(content relevance weightₙ) (where A, B, and C are constants used to give more weight to distance relevance, memory relevance, and content relevance weight respectively). Items may be presented in order of overall relevance of the item from highest weight to lowest.

In one or more embodiments, a “near” distance is a fixed distance (e.g., 5 km). Another “near” distance may be computed from a distance relative to the typical distance between the user and a location or another person. For example, near can be defined as 5% of the normal average distance between the two. If Persons A and B are typically 100 miles from each other, then “near” may be within 5 miles of one another. Similarly, if two people are typically 1,000 miles apart, being within 50 miles may constitute being nearby. To compute a distance between a user and a non-moving location, the following factors may be used: maintaining a history of the user's location, averaging samples to determine a “centroid” location, and computing the distance between the centroid and the location. A centroid is the average of all points. Data clustering algorithms (e.g., k-means) can be used to determine if the user's location history indicates location readings tend to happen in a few places where the user spends the most time, thereby indicating a cluster. In a preferred embodiment, normalization techniques may be used to compute the number of days in the last 90 days when the user was at a given location at least once.

Another example for determining the distance between a user and another person or a user and a location is to use address information (e.g. from an address book of the user). The addresses for locations and other people may be converted to a physical location using a Geographical Information System (GIS) database lookup with the address. With the physical location information form the GIS database, reminders can then be sent that relate to the location or other person associated with the address. The address for a person can be viewed as a typical location for the person and reminders associated with the person may be sent to the user when the user is near the address. Another example for determining typical locations for a person may be to acquire their address from their address book (e.g. on their computing device or via an on-line address book service). Alternate sources for addresses may include, but are not limited to: the white or yellow pages, or on-line services that map people and location names to street addresses, cities, and countries.

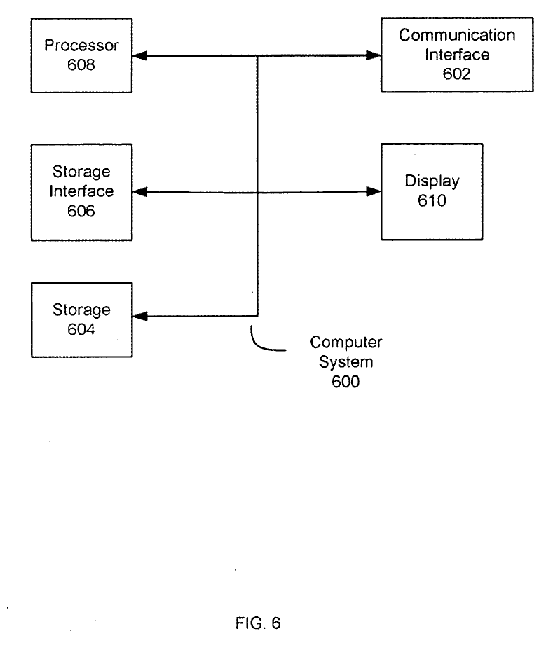

FIG. 6 depicts an exemplary block diagram for a system architecture of a computer system. The execution of instructions to practice the invention may be performed by any number of computer systems 600 as depicted in FIG. 6. As used herein, the term computer system is broadly used to describe any computing device that can store and independently run one or more programs, applications, scripts, or software processes. Implementations of the present invention may have a single computer system 600 or any number of computer systems 600.

Computer systems 600 may communicate with other computer systems/devices with any number of Communication Interface(s) 602. The Communication Interface 602 may provide the ability to transmit and receive signals, such as electrical, electromagnetic or optical signals, that include data streams representing various types of information (e.g. messages, communications, instructions, and data). The Communication Interface 602 may provide an implementation for a communication protocol, such as a network protocol. Instructions may be executed by a Processor 608 upon receipt and/or stored in Storage 604 accessible to the Computer System 600.

Storage 604 may be accessed by the Computer System 600 with a Storage Interface 606. The Computer System 600 may use the Storage Interface 606 to communicate with the Storage 604. The Storage Interface 606 may include a bus coupled to the storage and able to transmit and receive signals. Storage 604 may include random access memory (RAM) or other dynamic storage devices, for storing dynamic data and instructions executed by the Processor 608. Any number of Processor(s) 608 may be used to execute instructions for the Computer System 600. Storage may include, but is not limited to, read only memory (ROM), magnetic disks, flash drives, usb drives, and optical disks. In one or more embodiments, a Computer System 600 may be connected to a Display 610 for displaying information to a user.

“Computer usable medium” or “Computer-readable medium” refers to any medium that provides information or may be used by a Processor 608. Medium may include volatile and non-volatile storage mediums.

Various embodiments of the present invention may be implemented with the aid of computer-implemented processes or methods (e.g. programs or routines) that may be rendered in any computer language including, without limitation, C#, C/C++, Fortran, COBOL, PASCAL, Ruby, Python, assembly language, markup languages (e.g., HTML, SGML, XML, VoXML), and the like, as well as object-oriented environments such as the Common Object Request Broker Architecture (CORBA), Java™, and the like. In general, however, all of the aforementioned terms as used herein are meant to encompass any series of logical steps performed in a sequence to accomplish a given purpose.

In view of the above, it should be appreciated that some portions of this detailed description are presented in terms of algorithms and symbolic representations of operations on data within a computer memory. These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the description of the present invention, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention can be implemented with an apparatus to perform the operations described herein. This apparatus may be specially constructed for the required purposes, or it may comprise a general-purpose computer, selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor or by any combination of hardware and software. One of ordinary skill in the art will immediately appreciate that the invention can be practiced with computer system configurations other than those described below, including hand-held devices, multiprocessor systems, microprocessor-based or programmable consumer electronics, DSP devices, network PCs, minicomputers, mainframe computers, and the like. The invention can also be practiced in distributed computing environments where tasks are performed by remote processing devices that are linked through a communications network.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art. The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed:

1. A method for memory augmentation, comprising:
detecting a contextual factor for a user;
selecting a query for a database based upon the contextual factor;
receiving a query result comprising one or more reminders relevant to the user, wherein a reminder comprises information relevant to at least one of recalling and reinforcing, a memory,
selecting any number of reminders from the query result based upon an estimation of information beneficial for the user to receive, and
sending information from the selected reminders for presentation on a communication channel, wherein at least one of the information for presentation and the communication channel is selected based upon at least one of a situation and a state for the user.

2. The method of memory augmentation of claim 1, wherein the estimation comprises at least one of repetition estimation, forgetting estimation, overload estimation, and attention estimation of the user.

3. The method of memory augmentation of claim 1, further comprising
determining a situation for a user from one or more contextual factors.

4. The method of memory augmentation of claim 1, further comprises:
performing at least one of ranking and filtering of one or more reminders in the query result based upon the estimation.

5. The method of memory augmentation of claim 1, wherein information from a reminder is a media clip.

6. The method of memory augmentation of claim 1, further comprising:
learning appropriate information from reminders to present to the user over time.

7. The method of memory augmentation of claim 1, further comprising:
obtaining a contextual factor from a contextual factor sensor.

8. The method of memory augmentation of claim 7, wherein the contextual factor is a location.

9. A method for memory augmentation, comprising:
receiving information from a selected reminder for presentation on a communication channel, wherein selection of at least one of the information for presentation and the communication channel is based upon at least one of a situation and a state for the user, wherein selection of the selected reminder comprises:
detecting a contextual factor for a user;
selecting a query for a database based upon the contextual factor;
receiving a query result comprising one or more reminders relevant to the user, wherein a reminder comprises information relevant to at least one of recalling and reinforcing a memory; and
selecting a reminder from the query result based upon an estimation of information beneficial for the user to receive.

10. The method of memory augmentation of claim 9, wherein the estimation comprises at least one of repetition estimation, forgetting estimation, overload estimation, and attention estimation of the user.

11. A system for memory augmentation, comprising:
a contextual factor sensor configured to detect a contextual factor for a user;
a processor operable to execute a set of instructions; and
a computer-readable medium in communication with the processor, the computer-readable medium operable to store a set of instructions, wherein the set of instructions are configured to:
select a query for a database based upon the contextual factor;
receive a query result comprising one or more reminders relevant to the user, wherein a reminder comprises information relevant to at least one of recalling and reinforcing a memory;
select any number of reminders from the query result based upon an estimation of information beneficial for the user to receive; and
send information from the selected reminders for presentation on a communication channel, wherein at least one of the information for presentation and the communication channel is selected based upon at least one of a situation and a state for the user.

12. The system for augmentation of claim 11, wherein the estimation comprises at least one of repetition estimation, forgetting estimation, overload estimation, and attention estimation of the user.

13. The system for memory augmentation of claim 11, the set of instructions are further configured to:
determine a situation for a user from one or more contextual factors.

14. The system for memory augmentation of claim 11, the set of instructions are further configured to:
perform at least one of ranking and filtering one or more reminders in the query result based upon an estimation.

15. The system for memory augmentation of claim 11, wherein information from a reminder is a media clip.

16. The system for memory augmentation of claim 11, the set of instructions are further configured to:
learn appropriate information from reminders to present to the user over time.

17. The system for memory augmentation of claim 11, wherein the contextual factor is a location.

18. A computer-readable medium for memory augmentation, the computer-readable medium operable to store a set of instructions that may be executed on a computer system, wherein the set of instructions are configured to:
detect a contextual factor for a user;
select a query for a database based upon the contextual factor;
receive a query result comprising one or more reminders relevant to the user, wherein a reminder comprises information relevant to at least one of recalling and reinforcing a memory;
select any number of reminders from the query result based upon an estimation of information beneficial for the user to receive; and
send information from the selected reminders for presentation on a communication channel, wherein at least one of the information for presentation and the communication channel is selected based upon at least one of a situation and a state for the user.

19. The computer-readable medium of claim 18, wherein the estimation comprises at least one of repetition estimation, forgetting estimation, overload estimation, and attention estimation of the user.

20. The computer-readable medium of claim 18, the set of instructions are further configured to:
determine a situation for a user from one or more contextual factors.
